(19) United States
(12) Patent Application Publication
(10) Pub. No.: US 2010/0246921 A1
(43) Pub. Date: Sep. 30, 2010

(54) Radiographic image correction method and radiographic imaging apparatus

(75) Inventors: Kazuchika Iwami, Kanagawa (JP); Takao Kuwabara, Kanagawa (JP)

Correspondence Address: AKERMAN SENTERFITT, 8100 BOONE BOULEVARD, SUITE 700, VIENNA, VA, 22182-2683, US

(73) Assignee: FUJIFILM Corporation, Tokyo (JP)

(21) Appl. No.: 12/659,978

(22) Filed: Mar. 26, 2010

(30) Foreign Application Priority Data
Mar. 31, 2009 (JP) 2009-088213

(51) Int. Cl. G06T 7/00; G01N 23/04

(52) U.S. Cl. 382/132; 378/62

(57) ABSTRACT

A radiographic image correction method comprises the steps of: previously producing and storing a preparatory image by removing a radiographic image without the subject obtained by radiography using one of a plurality of target/filter combinations causing a least significant inconsistent density from a radiographic image without the subject obtained by radiography using one of the target/filter combinations causing a most significant inconsistent density, producing and storing a first correction image without the subject obtained by radiography using the target/filter combination causing the least significant inconsistent density, and combining the first correction image with the preparatory image to produce and store a second correction image, and correcting shading of a radiographic image obtained by radiographing the subject by removing one of the first and the second correction image depending upon the target/filter combination used for radiographing the subject from the radiographic image obtained by radiographing the subject.

### BACKGROUND OF THE INVENTION

The present invention relates to shading correction of a radiographic image and particularly to a radiographic image correction method suitable for a breast X-ray diagnostic apparatus and a radiographic imaging apparatus using that correction method.

In the examination of a breast cancer, the rate of discovering tumors in their early stages increases when visual examination and palpation are combined with screening using a breast X-ray diagnostic apparatus or a mammography machine that produces radiographic images of a breast. Therefore, a checkup using a breast X-ray diagnostic apparatus is made in addition to or in lieu of visual examination and palpation in a breast cancer screening.

In a breast X-ray diagnostic apparatus, a breast, placed on a radiographic table containing a radiographic image detector, is compressed by a compression plate, whereupon the breast is irradiated from the side thereof facing the compression plate, and the radiation that penetrated the breast is received by an imaging medium to produce a radiographic image of the breast in the imaging medium.

In radiographic imaging apparatuses including a breast X-ray diagnostic apparatus as described above and various other X-ray diagnostic apparatuses, a subject is irradiated with radiation emitted from a radiation source, whereupon the radiation that penetrated the subject is detected by a radiation detector to produce a radiographic image.

The radiation detector produces a radiographic image by converting radiation such as X-ray, α-ray, β-ray, γ-ray, electron beam, and ultraviolet ray into an electric signal to achieve radiographic imaging.

In radiographic imaging apparatuses, there is known a radiation source wherein electrons (thermal electrons) generated by, for example, a filament are caused to strike a target to generate radiation such as X-ray and emit the radiation through a filter.

Targets used for generating radiation may be made, for example, of tungsten or molybdenum. The filter cuts off unnecessary radiation and provides radiation in an appropriate dose suited for radiographic imaging. Known filters for this purpose include a filter made of molybdenum, rhodium, aluminum, and silver.

As a radiographic image detector is known a flat radiographic image detector or a so-called flat panel detector referred to as FPD below.

There are two types of FPDs: a direct type and an indirect type. The direct type, for example, collects and reads out electron-hole pairs generated by a photoconductive film such as one formed of amorphous selenium in response to incident radiation, as an electric signal. To be brief, the direct type directly converts radiation into an electric signal. The indirect type has a phosphor layer or a scintillator layer formed of a phosphor that emits light or fluoresces in response to incident radiation to convert radiation into visible light through that phosphor layer, reading out the visible light with a photoelectric transducer. Briefly, the indirect type converts radiation into visible light and the visible light into an electric signal.

One of the causes for quality degradation of radiographic images produced by a radiographic imaging apparatus is inconsistent density or so-called shading due to a cause specific to an individual apparatus such as inconsistent sensitivity of the FPD.

Shading can obviously be a primary cause of image deterioration. Degradation of image quality, in turn, can well be a cause of false diagnosis. Therefore, shading correction, i.e., image processing for correcting shading or inconsistent density, is performed in radiographic imaging apparatuses.

Shading correction is typically performed by preparing a correction image (shading image) for shading correction and processing a radiographic image with this correction image.

JP 9-166555 A, for example, describes a radiographic image shading correction method wherein the whole surface of the radiation detector is irradiated with a given dose of radiation to produce a so-called solid image or an exposed solid radiographic image, which is used to produce and store in memory a correction image or a shading image, which in turn is used to correct a radiographic image produced by the radiation detector against the correction image.

### SUMMARY OF THE INVENTION

There are cases where the target and/or the filter of the radiation source is replaced in some radiographic imaging apparatuses, specifically breast X-ray diagnostic apparatuses, in order to obtain an optimum radiographic image according to the kind and status of the subject. Thus, in these apparatuses, the same target and the same filter are not always used for radiographic imaging.

Some kinds of filters may cause structural inconsistency in density or filter structure noise specific to those filters, which may be superimposed on the shading caused by the above-mentioned inconsistent sensitivity, etc. of the FPD. A filter is typically a sheet member made of such a material as described above having a thickness of about 25 μm to 50 μm. Because it is thin, its thickness is liable to vary. This variation in thickness in turn causes a planar variation in the amount of radiation transmitted through the filter, producing inconsistent image density.

Accordingly, a conventional shading correction method as described in JP 9-166555 A may certainly achieve shading correction on a radiographic image produced using the same target and the filter that are used to produce the correction image or the shading image but fails to perform required shading correction on a radiographic image produced using a different target and a different filter, resulting in a radiographic image where an inconsistent density due, in particular, to the filter stands out.

It is an object of the present invention to solve the above problems with said prior art and provide a radiographic image correction method and a radiographic imaging apparatus for implementing this method whereby appropriate shading correction or correction of inconsistent density specific to individual apparatuses can be performed on a radiographic image produced by a radiographic imaging apparatus regardless of the combination of target and filter and whereby the number of radiographic images needed can be greatly reduced because correction data is obtained in only a required number of pieces.

A radiographic image correction method according to the invention comprises the steps of: presetting a plurality of target/filter combinations each of which contains one of targets and one of filters, previously producing and storing a preparatory image by removing a radiographic image without the subject obtained by radiography using one of the target/filter combinations causing a least significant inconsistent density from a radiographic image without the subject obtained by radiography using one of the target/filter combinations causing a most significant inconsistent density, producing and storing a first correction image without the subject obtained by radiography using the target/filter combination causing the least significant inconsistent density and renewed at a timing preset in a radiographic imaging apparatus used to produce the radiographic image, and combining the first correction image with the preparatory image to produce and store a second correction image, and correcting shading of a radiographic image obtained by radiographing the subject by removing one of the first correction image and the second correction image depending upon the target/filter combination used for radiographing the subject from the radiographic image obtained by radiographing the subject.

A radiographic imaging apparatus according to the invention comprises: a plurality of targets each generating radiation when struck by electrons and a plurality of filters each transmitting the radiation therethrough generated by one of the targets used therewith to adjust a dose of radiation, target changing means for changing a target and filter changing means for disposing a filter in a given position according to a selected one of target/filter combinations each containing one of the targets and one of the filters, a radiation detector for producing a radiographic image from radiation transmitted through the filter, preparatory image storage means for previously producing and storing a preparatory image obtained by removing a radiographic image without the subject obtained using one of the target/filter combinations causing a least significant inconsistent density from a radiographic image without the subject obtained using one of the target/filter combinations causing a most significant inconsistent density, correction image storage means for producing and storing a first correction image without the subject obtained by radiography using the target/filter combination causing the least significant inconsistent density, producing and storing a second correction image obtained by combining the first correction image with the preparatory image stored in the preparatory image storage means, and renewing the first correction image and the second correction image at a given timing, and shading correction means for performing shading correction on the radiographic image obtained by radiographing the subject by selecting either the first correction image or the second correction image stored in the correction image storage means depending upon the target/filter combination used for radiography and removing a selected correction image from the radiographic image obtained as the radiation detector radiographs the subject.

### BRIEF DESCRIPTION OF THE DRAWINGS

FIG. 1 is a view illustrating a schematic configuration of a breast radiological diagnostic apparatus according to an embodiment of the invention.

FIG. 2 is a view illustrating a schematic configuration of a radiation unit of the radiological diagnostic apparatus of FIG. 1.

FIG. 3 is a sectional view illustrating a schematic configuration of a radiographic table of the radiological diagnostic apparatus of FIG. 1.

FIG. 4 is a block diagram illustrating a schematic configuration of an image processor of the radiological diagnostic apparatus of FIG. 1.

FIGS. 5A to 5D illustrate a concept of the radiographic image correction method according to the invention; FIG. 5E illustrates a concept of a conventional radiographic image correction method.

### DETAILED DESCRIPTION OF THE INVENTION

Now, the radiographic image correction method and the radiographic imaging apparatus according to one embodiment of the invention will be described in detail referring to the accompanying drawings.

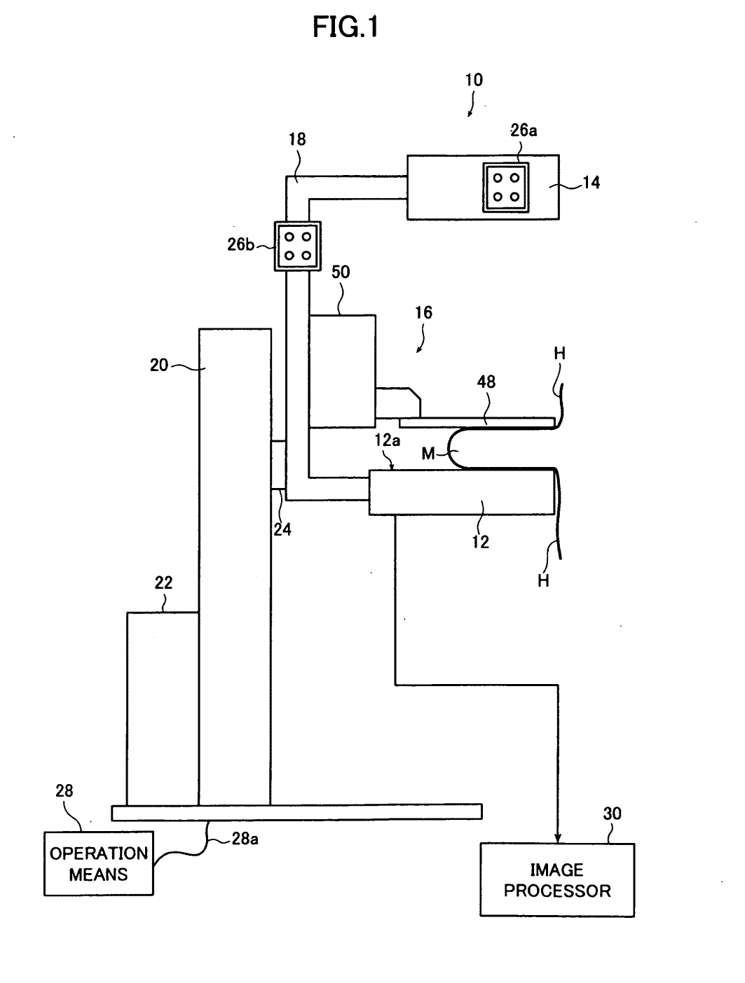

FIG. 1 is a view illustrating a schematic configuration of a breast X-ray diagnostic apparatus using a radiographic imaging apparatus according to one embodiment of the invention.

The present invention is not limited in application to breast X-ray diagnostic apparatuses and may be used for all radiographic imaging apparatuses such as X-ray diagnostic apparatuses for examination of lower limbs.

A breast X-ray diagnostic apparatus 10 illustrated in FIG. 1, referred to as diagnostic apparatus 10 below, is an apparatus for radiographing a breast for breast cancer screening or other like purposes.

As illustrated in FIG. 1, the diagnostic apparatus 10 basically comprises a radiographic table 12, a radiation unit 14, compression means 16, an arm 18, a stand 20, a high-voltage X-ray radiation power source 22, and an image processor 30.

The diagnostic apparatus 10 is basically the same as a normal breast X-ray diagnostic apparatus or a mammography machine except that the former performs inconsistent image density correction or shading correction described later. In FIG. 1 and others, a letter M schematically indicates a breast, and a letter H a subject or a chest wall.

In the diagnostic apparatus 10, the arm 18 has a substantially C-shaped configuration bent at two places at right angles. It has the radiation unit 14 attached to the upper end thereof as seen in FIG. 1 and the radiographic table 12 attached to the lower end thereof. The compression means 16 is fixedly provided between the radiation unit 14 and the radiographic table 12.

The arm 18 is supported by the stand 20 through a shaft 24. The stand 20 contains means for turning the shaft 24 and means for lifting and lowering the shaft 24. The arm 18 is lifted and lowered together with the radiographic table 12 and the radiation unit 14 as the shaft 24 is lifted and lowered by the means for lifting and lowering the shaft 24; the arm 18 is turned in a direction normal to FIG. 1 as shaft 24 is turned by the means for turning the shaft 24. The angle of the arm 18 is thus adjusted to permit MLO radiography (taking radiographs from a mediolateral oblique view).

The radiation unit 14 comprises operation means 26a. The arm 18 comprises operation means 26b. The stand 20 comprises operation means 28.

In this embodiment, the operation means 26a is provided on a lateral side of the radiation unit 14. The operation means 26b is provided on a lateral side of the arm 18. Both operation means have, among others, switches for turning and lifting/lowering the arm 18 and a switch for turning on a light for illuminating the radiation exposure field. The operation means 28 is a foot pedal type connected to the stand 20 through a cable 28a and comprises switches for lifting and lowering a compression plate 48 described later and switches for lifting and lowering the arm 18.

The radiation unit 14 irradiates the breast M and an FPD 56 with radiation.

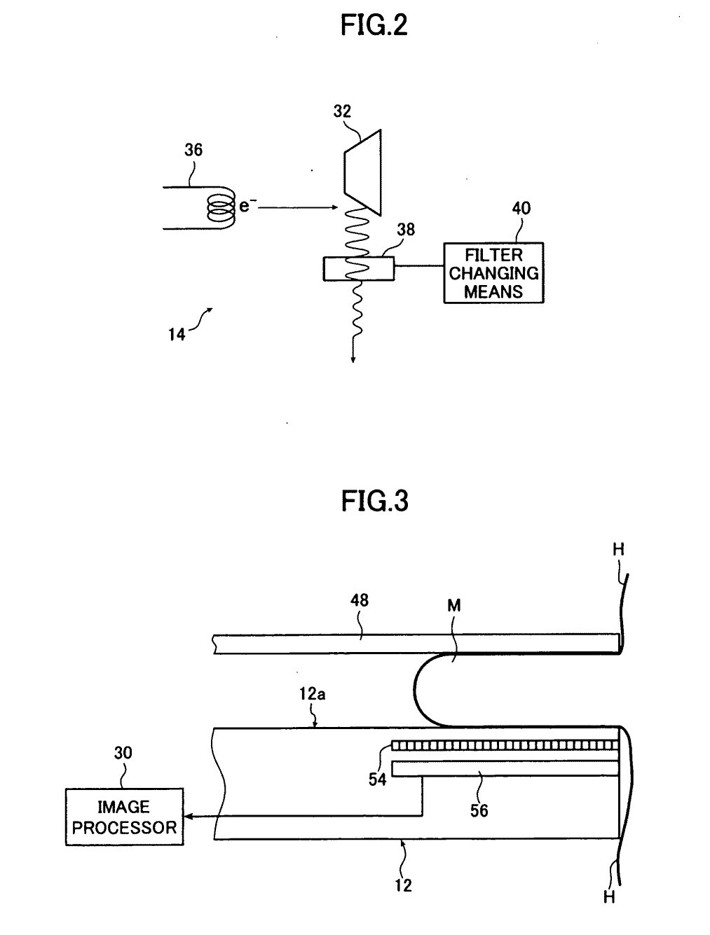

FIG. 2 illustrates a configuration of the radiation unit 14.

The radiation unit 14 comprises a target 32, an electron beam source 36, a filter 38, and filter changing means 40.

Besides these, the radiation unit 14 may further comprise other components provided in a typical radiographic imaging apparatus such as a collimator that limits the radiation exposure field.

The radiation unit 14, a known component used in a radiographic imaging apparatus, causes electrons e⁻ or thermoelectrons emitted from the electron beam source 36 to hit the target 32, generating X ray (radiation), which is caused to enter the breast M and the radiographic table 12 (FPD 56) via the filter 38.

The electron beam source 36 is a known electron beam source configured using, for example, a filament and causes electrons e⁻ to enter the target 32 that emits radiation in a radiographic imaging apparatus.

The target 32 is a known target used in a radiographic imaging apparatus. When struck by electrons e⁻, the target 32 generates radiation as the electrons e⁻) and a substance of which the target is made react.

The target 32 is not limited specifically and may be any of various types used in radiographic imaging apparatuses. The number of targets 32 used is also not limited. By way of example, two targets, a molybdenum target (Mo target) and a tungsten target (W target) are provided as the target 32 in this embodiment.

The filter 38 is a known filter used in a radiographic imaging apparatus to absorb X ray generated by the target 32 and render the X ray most suitable to the status of the breast M before it enters the breast M.

The filter 38 is not limited specifically and may be any filter used in radiographic imaging apparatuses such as a molybdenum filter, a rhodium filter (Rh filter), an aluminum filter (Al filter), or a silver filter (Ag filter). The number of filters 38 used is also not limited. In this embodiment, three filters are provided by way of example: a molybdenum filter, a 25-μm thick rhodium filter, and a 50-μm thick rhodium filter.

As described above, a molybdenum target and a tungsten target are provided as target 32. The target changing means changes the radiation position of the electron beam emitted from the electron beam source 36 to switch kinds of the target 32 that generates X ray. The filter changing means 40 switches between filters 38, i.e., between the molybdenum filter and the rhodium filter.

Both means are known target changing means and filter changing means used in breast X-ray diagnostic apparatuses.

In a typical breast X-ray diagnostic apparatus (a radiographic imaging apparatus comprising a plurality of targets and/or filters), the targets and the filters are used in a combination such that optimum radiation may be caused to enter the breast M according to the status of the breast M, etc.

In this embodiment, three combinations of the target 32 and the filter 38 are provided for selection depending upon the status of the breast M to be radiographed: a molybdenum target and a molybdenum filter; a molybdenum target and a 25-μm thick rhodium filter; and a tungsten target and a 50-μm thick rhodium filter.

The electron beam source 36 irradiates the target of a selected combination with electron beam; the filter changing means 40 disposes the filter 38 of the selected combination in a given position.

The compression means 16 depresses the breast M onto the radiographic table 12 for radiography and comprises a compression plate 48 for depressing the breast M onto the radiographic table 12 and lifting means 50 for lifting and lowering the compression plate 48. The compression plate 48 is removably attached to the lifting means 50 and provided by way of example in different sizes: one measuring 18 cm×24 cm for a normal size breast M and another measuring 24 cm×30 cm for a larger breast M.

The compression plate 48 and the lifting means 50 according to this embodiment are basically a known compression plate and known lifting means therefor provided in known radiographic breast imaging apparatuses.

The radiographic table 12 is a hollow housing member having a top surface 12a on which the breast M is placed as seen in FIG. 1; it comprises therein a scattering removal grid 54 and the FPD 56 as schematically illustrated in FIG. 3.

The radiographic table 12 further contains as necessary an AEC (automatic exposure control) sensor for measuring radiation transmitted through the breast M in preliminary irradiation conducted before radiographing to determine imaging conditions, moving means for moving the scattering removal grid 54, etc., provided in known breast examination apparatuses.

The scattering removal grid 54 is a known grid provided in radiographic imaging apparatuses to prevent scattering radiation from entering the FPD 56.

The FPD 56 is a known radiographic image detector or a solid state radiation detector that detects radiation emitted by the radiation unit 14 (radiation source) and allowed to penetrate the breast M of a subject H

The FPD 56 is a known FPD or a flat panel detector used in various types of radiographic imaging apparatuses and has pixels for two-dimensionally detecting radiation in x-y directions, i.e., an x direction and a y direction crossing each other at right angles.

The FPD 56 may be a so-called direct-type FPD or a so-called indirect-type FPD. A typical direct-type FPD, employing a photoconductive film such as one formed of amorphous selenium, collects and reads out electric charge, i.e., electron-hole pairs, generated by the photoconductive film in response to incident radiation as an electric signal. The indirect-type, employing a photodiode and a scintillator layer formed of a phosphor such as CsI:Tl that emits light or fluoresces in response to incident radiation, photoelectrically converts the light emitted by the scintillator layer in response to incident radiation into an electric signal and reads it out.

A radiographic image of the breast M produced by the FPD 56 or an output signal produced by the FPD 56 is supplied to the image processor 30.

The image processor 30 processes the output signal of the FPD 56 to produce image data (image signal) for a monitor to display an image, for a printer to produce a print output, and for use over a network or in recording media or other designated locations. The image processor 30 is formed, for example, of a computer and controls and manages the entire diagnostic apparatus 10. The image processor 30 also forms a part of radiography menu selection means, selection means for selecting a combination of the target 32 and the filter 38 described earlier, and other means.

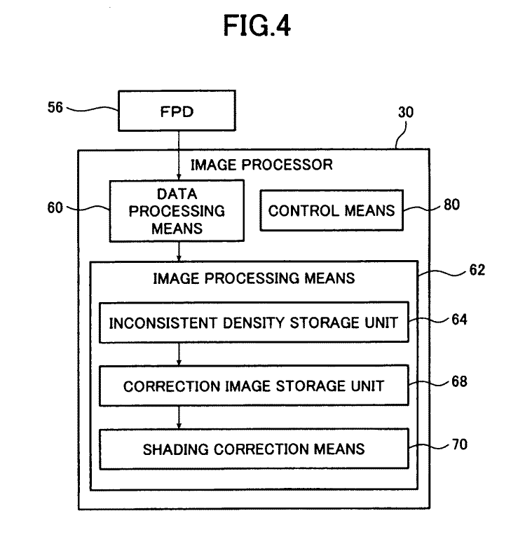

In the diagnostic apparatus 10, the image processor 30 comprises control means 80 for controlling and managing data processing means 60, the image processing means 62, and the diagnostic apparatus 10 as illustrated in the block diagram of FIG. 4.

Thus, an embodiment of the image processor 30 comprises one or more computers and workstations and comprises other components where necessary than are illustrated, such as a keyboard and a mouse, to perform various operations including entering of instructions.

The data processing means 60 performs given processing such as analog-to-digital conversion on the output signal of the FPD 56 to obtain and supply a radiographic image (image data or image signal) of the breast M to the image processing means 62.

The image processing means 62 performs given processing on the radiographic image supplied from the data processing means 60 and produces image data for a monitor to display an image, for a printer to produce a print or a hard copy, and for use over a network or for use in storage media or other designated locations.

The image processing performed by the image processor 62 is not limited specifically. Thus, the image processor 62 is capable of all kinds of image processing performed by various radiographic imaging apparatuses and image processing apparatuses including offset correction, pixel defect correction, residual image correction, tone correction, density correction, and data conversion whereby a radiographic image is converted into an output image for a monitor to display or for a printer to print out. All these corrections may be performed by a known method.

The image processing means 62 performs shading correction by the radiographic image correction method according to the invention, i.e., inconsistent image density correction specific to the diagnostic apparatus 10. The image processing means 62 comprises a filter inconsistent density storage unit 64 (referred to as “inconsistent density storage unit 64” below), a correction image storage unit 68, and shading correction means 70.

The inconsistent density storage unit 64 produces and stores image data having inconsistent density due to the filter 38, i.e., image data containing shading (filter structure noise) due to the filter 38 that causes the most significant inconsistent density among the combinations of the target 32 and the filter 38 set in the diagnostic apparatus 10.

Since the radiation unit 14 uses two kinds of rhodium filters different in thickness and a molybdenum filter as the filter 38, the inconsistent density storage unit 64 produces and stores image data having inconsistent density due to the 25 μm-thick rhodium filter that produces the most significant inconsistent density. In a preferred embodiment, the inconsistent density storage unit 64 also produces and stores image data having inconsistent density due to the 50 μm-thick rhodium filter that produces the second most significant inconsistent density.

As described above, the filter 38 removes unnecessary X ray from the X-ray generated by the target 32 to produce radiation that best suits the radiography of the breast M.

The filter 38 is a plate member made of a material such as rhodium or molybdenum that absorbs X ray and is so thin as 25 μm to 50 μm in thickness, i.e., in the direction in which X ray is transmitted that it is difficult to fabricate the filter 38 with a consistent thickness throughout the whole area, resulting in inconsistency in thickness. The inconsistency in thickness in turn can be a cause of inconsistent density of a radiographic image.

Some kinds of the target 32 may cause the same structural inconsistent density as the filter but only to such a negligible degree in most cases that substantially does not affect the image quality.

The inconsistent density of the filter 38 varies with the kind of the filter 38. For example, although the inconsistent density due to a molybdenum filter only affects the image quality to a negligible degree in most cases, the 25-μm thick rhodium filter causes an inconsistent density that affects the image quality to a significant degree. The inconsistent density due to the 50-μm thick rhodium filter can also be a cause of image degradation though to a lesser degree than is the case with the 25-μm thick rhodium filter.

In this embodiment, the inconsistent density storage unit 64 produces and stores image data of inconsistent density due to the filter 38 that produces the most significant inconsistency density. Specifically, the inconsistent density storage unit 64 produces and stores image data having inconsistent density due to the 25 μm-thick rhodium filter. In a preferred embodiment, the inconsistent density storage unit 64 also produces and stores image data having inconsistent density due to the 50 μm-thick rhodium filter.

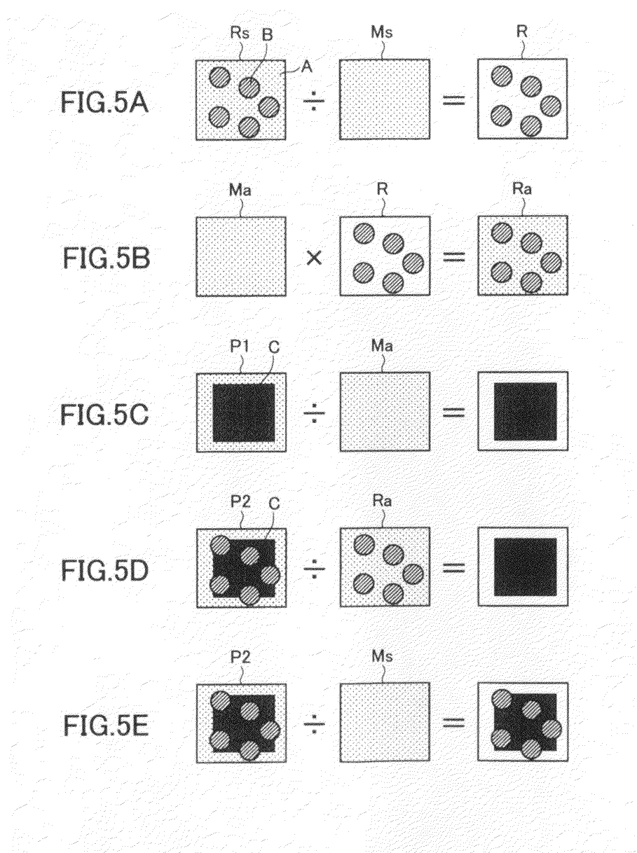

Now, referring to FIG. 5A, a method will be described of producing image data of inconsistent density due to the 25-μm thick rhodium filter that produces the most significant inconsistent density.

First, the whole area of the FPD 56 is evenly irradiated with X ray to produce a solid image Rs using a combination including the filter 38, say the molybdenum target and the 25-μm thick rhodium filter, that causes the most significant inconsistent density. The image Rs contains inconsistent density due to inconsistent sensitivity due to the FPD 56, etc. indicated by a dotted area A and inconsistent density due to the filter 38 indicated by a shaded area B.

Next, the whole area of the FPD 56 is evenly irradiated with the same dose of X ray as used to produce the image Rs in order to produce an image Ms using a combination including a filter, say the molybdenum target and the molybdenum filter according to this embodiment, that causes the least significant inconsistent density. Generally, inconsistent density due to a filter that causes the least significant inconsistent density is of such a negligible magnitude that the image Ms only contains inconsistent density due, for example, to inconsistent sensitivity specific to the diagnostic apparatus 10.

Then, the image Rs is divided by the image Ms to remove the image Ms from the image Rs, thereby producing an image R of inconsistent density due to the rhodium filter, which image R is stored in the inconsistent density storage unit 64. When processing is performed on image data obtained after logarithmic conversion of the output signal of the FPD 56, the image Ms is subtracted from the image Rs to produce the inconsistent density image R.

As described above, the image Rs contains inconsistent density due to the rhodium filter and inconsistent density due to inconsistent sensitivity whereas the image Ms only contains inconsistent density due to inconsistent sensitivity. Since both images are produced with the same dose of radiation, the inconsistent density image R only represents inconsistent density B due to the rhodium filter, i.e., the filter 38.

In a preferred embodiment, the inconsistent density image R is processed using a spatial frequency filter to attenuate the high frequency waves of the inconsistent density image R and reduce the random noise, completing the inconsistent density image R, which is stored in the inconsistent density storage unit 64.

The cutoff frequency of the spatial frequency filter is not limited specifically. The cutoff frequency of the spatial frequency filter, when too low, causes the inconsistent density due to the filter 38 to blur although the effects produced by reduction in random noise of the inconsistent density image R are obtained, and, therefore, the inconsistent density due to the filter 38 cannot be fully corrected by the shading correction. Conversely, when the cutoff frequency of the spatial frequency filter is too high, the effects produced by reduction in random noise of the inconsistent density image R are not sufficient although the effects produced by correcting the inconsistent density due to the filter 38 are sufficient.

Thus, an optimum cutoff frequency of the spatial frequency filter for processing the inconsistent density image R varies with the spatial frequency of the inconsistent density due to the filter 38. Therefore, an optimum cutoff frequency may be set as appropriate by conducting experiments, simulations, and the like.

An image of inconsistent density due to the 50-μm thick rhodium filter may be likewise produced using the tungsten target and the 50-μm thick rhodium filter.

The inconsistent density image R may be produced by the inconsistent density storage unit 64 or another unit of the diagnostic apparatus 10 or, alternatively, by a device outside of the diagnostic apparatus 10 such as a computer performing computation, and stored in the inconsistent density storage unit 64.

Preferably, the inconsistent density image R is produced and stored, for example, before the shipment of the diagnostic apparatus 10.

To achieve a high-accuracy shading correction, the inconsistent density image R needs to be produced separately according to the individual imaging conditions.

Suppose that the imaging conditions set in the apparatus include, in addition to the combination of the target 32 and the filter 38, a time period during which an electric voltage is applied to the FPD 56 or a voltage application time (time period during which electrons ionized by incident radiation are stored in the FPD 56 or an accumulation time), a radiated dose of X ray or radiation, and a focus size: specifically, six different voltage application times, two different doses of X ray, and two different focus sizes, one for magnification radiography and the other for normal radiography.

In this case, 6×2×2=24 inconsistent density images R need to be produced. Specifically, radiography needs to be repeated 24 times using the 25-μm thick rhodium filter to produce consistent density images and likewise, radiography needs to be repeated 24 times using the molybdenum filter to produce consistent density images in order to produce 24 inconsistent density images R. Accordingly, in this embodiment wherein inconsistent density images obtained using the 50-μm thick rhodium filter are also stored, radiography needs to be repeated a total of 48 times to produce 48 inconsistent density images R.

Because its spatial frequency is low, the data of the inconsistent density image R can be appropriately compressed.

Therefore, the inconsistent density storage unit 64 preferably stores the inconsistent density image R as compressed.

A correction image storage unit 68 produces and stores a correction image (shading image or correction data) for performing shading correction on a radiographic image.

Inconsistent density due to the filter 38 scarcely changes but inconsistent density due to inconsistent sensitivity of the diagnostic apparatus 10 such as inconsistent sensitivity of the FPD 56 does change with time. Therefore, the correction image storage unit 68 needs to reproduce a correction image at a given timing that is set in the diagnostic apparatus 10. Thus, the correction image storage unit 68 renews the correction image at a given timing and stores the renewed correction image.

The correction image renewal timing is not limited specifically; the renewal may be made periodically, say every day, once every three months, or once every six months; every time the diagnostic apparatus is started; whenever a renewal instruction is given; or in combination of these timings.

By way of example, a correction image is produced by the correction image storage unit 68 as follows.

First, the whole area of the FPD 56 is evenly irradiated with X ray to produce an image (original image) using a combination including the filter 38, say the molybdenum target and the molybdenum filter according to this embodiment, that causes the least significant inconsistent density. Then, the original image is averaged to produce an averaged image. Finally, the original image is divided by the averaged image (subtraction is performed in lieu of division in the case of data obtained by logarithmic conversion) to produce and store a first correction image Ma. Alternatively, the first correction image Ma may be produced by dividing the original image by a density corresponding to the radiated dose of X ray (by subtracting such density from the original image) in lieu of dividing the original image by the averaged image.

Upon producing the first correction image Ma, the first correction image Ma is multiplied by the inconsistent density image R stored in the inconsistent density storage unit 64 (addition is performed in lieu of multiplication in the case of data obtained by logarithmic conversion) to produce and store a second correction image Ra as illustrated in FIG. 5B.

The first correction image Ma is a correction image having a shading corresponding to radiography using the combination of the molybdenum target and the molybdenum filter; the second correction image Ra is a correction image having a shading corresponding to radiography using the combination of the molybdenum target and the rhodium filter.

A correction image having a shading corresponding to radiography using the combination of the tungsten target and the rhodium filter may also be produced and stored in exactly the same manner as the second correction image Ra using the image stored in the inconsistent density storage unit 64 and having inconsistent density due to the 50-μm thick rhodium filter.

When the image having inconsistent density due to the 50-μm thick rhodium filter is not stored, an image may be produced by radiography performed by evenly irradiating the whole area of the FPD 56 with X ray using the tungsten target and the rhodium filter, followed by the same procedure as described above for the first correction image Ma, to produce a correction image for correcting a shading corresponding to radiography using the combination of the tungsten target and the rhodium filter.

A correction image for correcting a shading corresponding to the combination of the tungsten target and the rhodium filter will be referred to below as a third correction image for the purpose of the invention.

To achieve a high-accuracy shading correction, the first correction image Ma, the second correction image Ra, and the third correction image preferably are all produced separately according to the imaging conditions.

Specifically, three combinations of the target 32 and the filter 38 are provided for selection in this embodiment: a molybdenum target and a molybdenum filter; a molybdenum target and a 25-μm thick rhodium filter; and a tungsten target and a 50-μm thick rhodium filter. Suppose that the imaging conditions include, in addition to the combination of the target 32 and the filter 38, a time period during which an electric voltage is applied to the FPD 56 or a voltage application time, a radiated dose of X ray, and a focus size: specifically, six different voltage application times, two different doses of X ray, and two different focus sizes, one for magnification radiography and the other for normal radiography. Then, a total of 3×6×2×2=72 correction images, i.e., the first correction image Ma, the second correction image Ra, and the third correction image, need to be produced.

In this case, the diagnostic apparatus 10 needs to renew the 72 correction images periodically, say once every six months, for example.

Accordingly, when using a conventional method of correcting inconsistent density, a radiographic diagnostic apparatus needs to periodically produce 72 radiographic images to achieve a high-accuracy shading correction.

However, the number of radiographic images that need to be produced is reduced to ⅓ according to this embodiment of the diagnostic apparatus 10 whereby the inconsistent density image R and an image having inconsistent density due to the 50-μm thick rhodium filter produced, for example, prior to shipment and stored in the inconsistent density storage unit 64 on the one hand and the first correction image produced from an image obtained using the molybdenum target and the molybdenum filter, i.e., an image obtained using a combination including the filter 38 that causes the least significant density, on the other hand to produce the second correction image Ra for correcting a shading corresponding to radiography using the combination of the molybdenum target and the 25-μm thick rhodium filter and the third correction image for correcting a shading corresponding to radiography using the combination of the tungsten target and the 50-μm thick rhodium filter.

Thus, according to this embodiment, producing 24 images using a combination of the molybdenum target and the molybdenum filter suffices to produce shading correction images corresponding to 72 different imaging conditions including three combinations of the target 32 and the filter 38.

Where the image having inconsistent density due to the 50-μm thick rhodium filter is not stored, producing 48 images suffices to produce shading correction images corresponding to 72 different imaging conditions including three combinations of the target 32 and the filter 38. In this case, therefore, the number of radiographic images for renewal of the correction images for shading correction can be reduced to ⅔.

Thus, this embodiment of the invention can greatly reduce the time and effort for renewing shading correction images as compared with the prior art.

In addition to the combination of the target 32 and the filter 38, the time period during which an electric voltage is applied to the FPD 56, the radiated dose of X ray, and the focus size, the imaging conditions according to this embodiment may include various other imaging conditions, and correction images corresponding to these may be produced and stored.

Presence and absence of a grid, for example, may be added to the imaging conditions. In this case, the number of correction images that need to be produced increase accordingly.

To produce appropriate radiographic images that suit the individual diagnoses, the imaging conditions preferably include at least the combination of the target 32 and the filter 38, the time period during which an electric voltage is applied to the FPD 56, the radiated dose of X ray, and the focus size according to this embodiment.

Shading correction means 70 performs shading correction on a radiographic image taken by the FPD 56 using one of the first correction image, the second correction image, and the third correction image produced by and stored in the correction image storage unit 68.

Shading correction by the shading correction means 70 may be performed basically in the same manner as a normal shading correction except that a correction image corresponding to the filter 38 used to take the radiographic image is selected and is not limited to the method described below.

As illustrated in FIG. 5C, the shading correction means 70 divides a radiographic image P1 (where a subject is represented by C) obtained by radiographing the subject with a combination of the molybdenum target and the molybdenum filter by the first correction image Ma (or subtracts the first correction image Ma from the radiographic image P1) to achieve shading correction. As illustrated in FIG. 5D, the shading correction means 70 also divides a radiographic image P2 (where a subject is represented by C) obtained by radiographing the subject with a combination of the molybdenum target and the 25-μm thick rhodium filter by the second correction image Ra produced using the inconsistent density image R (or subtracts the second correction image Ra from the radiographic image P2) to achieve shading correction on a radiographic image of interest.

To perform shading correction on a radiographic image obtained using a combination of the tungsten target and the 50-μm thick rhodium filter, the shading correction means 70 likewise divides the radiographic image P2 obtained by radiographing a subject by the third correction image (or subtracts the third correction image from the radiographic image P2).

Where the inconsistent density due to the 50-μm thick rhodium filter does not pose any problem with an image quality required of the diagnostic apparatus 10, shading correction on a radiographic image produced with the tungsten target and the rhodium filter may be performed using the first correction image Ma without producing/storing a shading correction image corresponding to the tungsten target and the rhodium filter.

Conventional shading correction described in the prior art such as JP 9-166555 A uses only a correction image corresponding to one kind of filter (e.g., the first correction image Ma) in lieu of using a filter for providing an optimum dose of radiation. Therefore, in the case of an inconsistent image density due to a filter that is not the filter used to produce that correction image, appropriate shading correction cannot be achieved, allowing inconsistent density due to the filter to remain in the image that has undergone shading correction as illustrated in FIG. 5E.

In contrast, this embodiment uses not only the first correction image Ma for shading correction produced using the filter 38 that causes the least significant inconsistent density but also the second correction image Ra for shading correction produced using the filter 38 that causes the most significant inconsistent density and uses the second correction image Ra to perform shading correction on the radiographic image P2 produced with the filter 38 that causes the most significant inconsistent density 38 and the first correction image Ma to perform shading correction on the other radiographic image P1.

Therefore, this embodiment is capable of appropriate shading correction specific to the filter 38 used to produce a radiographic image of interest and enables consistent production of a high-quality radiographic image free from inconsistent density.

Now, the effects of the diagnostic apparatus 10 will be described below.

The diagnostic apparatus 10 has stored in the inconsistent density storage unit 64 of the image processor 30 the inconsistent density image R produced using the filter 38 that causes the most significant inconsistent density or the 25-μm rhodium filter. In a preferred embodiment, the inconsistent density storage unit 64 also stores an inconsistent density image produced using the 50 μm-thick rhodium filter.

The correction image storage unit 68 further stores the first correction image Ma produced using the combination of the molybdenum target and the molybdenum filter that causes the least significant inconsistent density, the second correction image Ra produced using the first correction image Ma and the inconsistent density image R produced using the 25-μm thick rhodium filter stored in the inconsistent density storage unit 64 as illustrated in FIG. 5B, and the third correction image produced using the first correction image Ma and the inconsistent density image produced using the 50-μm thick rhodium filter stored in the inconsistent density storage unit 64. The first correction image Ma, the second correction image Ra, and the third correction image are renewed at given intervals, say once every six months, for example.

Selection from a radiography menu is made to choose a target 32 and a filter 38 for radiography whereupon the filter changer means 40 places a selected filter 38 in a given position.

The compression plate 48 having dimensions matching the breast M is attached, and an instruction is given by a radiologist, whereupon the lifting means 50 lowers the compression plate 48 to compress the right breast of a subject. Upon the compression of the right breast by the compression plate 48 reaching a given state, the radiation source of the radiation unit 14 emits radiation to perform preliminary radiation to set imaging conditions. Then, the selected target 32 is irradiated with X ray emitted from the electron beam source 36 to radiograph the breast M, producing a radiographic image of the breast M in the FPD 56.

The output signal of the FPD 56 is supplied to the data processing means 60 of the image processor 30, which perform given processings including analog-to-digital conversion to produce a radiographic image.

The thus produced radiographic image of the breast M is sent to the image processing means 62, which performs given processings such as tone correction and density correction on the radiographic image and supplies the corrected image to terminals such as a monitor and a printer as a radiographic image (image data) that can be used to produce image outputs.

In image processing, the shading correction means 70 reads out one of the first correction image Ma, the second correction image Ra, and the third correction image depending upon the combination of the target 32 and the filter 38 used for radiography and use the read-out correction image for shading correction of the radiographic image.

As described above, three different combinations of the target 32 and the filter 38 are set in the diagnostic apparatus 10. When the combination of the molybdenum target and the molybdenum filter is selected, the shading correction means 70 reads out the first correction image Ma from the correction image storage unit 68 and uses it for shading correction. When the combination of the molybdenum target and the 25-μm thick rhodium filter is selected, the shading correction means 70 reads out the second correction image Ra from the correction image storage unit 68 and uses it for shading correction. When the combination of the tungsten target and the 50-μm thick rhodium filter is selected, the shading correction means 70 reads out the third correction image from the correction image storage unit 68 and uses it for shading correction.

While the radiographic image correction method and the radiographic imaging apparatus have been described in detail with reference to preferred embodiments, it is to be understood that various changes and modifications may be made without departing from the true spirit and scope of the invention.

For example, images of inconsistent density due to a filter are produced and stored using a filter that causes the most significant inconsistent density and a filter that causes the second most significant inconsistent density in the above examples, the invention is not limited thereto.

Only an inconsistent density image corresponding to a filter that causes the most significant inconsistent density may be produced and stored or an inconsistent density image corresponding to a filter that causes the second or third most significant inconsistent density or any other filter that causes inconsistent density that should preferably be corrected may be previously produced and stored so that these inconsistent density images may be used together with the first correction image to produce correction images for shading correction when renewing the correction images, thereby achieving shading correction using a correction image corresponding to the filter used when the radiographic image is produced.

The present invention can be optimally applied to shading correction for diagnostic apparatuses for radiographing breast cancer and various radiographic imaging apparatuses using a plurality of radiation filters.

What is claimed is:

1. A radiographic image correction method of correcting shading of a radiographic image produced by irradiating a subject through a filter with radiation generated as electrons hit a target and detecting the radiation transmitted through the subject with a radiation detector, the method comprising:
presetting a plurality of target/filter combinations each of which contains one of targets and one of filters,
previously producing and storing a preparatory image by removing a radiographic image without the subject obtained by radiography using one of the target/filter combinations causing a least significant inconsistent density from a radiographic image without the subject obtained by radiography using one of the target/filter combinations causing a most significant inconsistent density,
producing and storing a first correction image without the subject obtained by radiography using the target/filter combination causing the least significant inconsistent density and renewed at a timing preset in a radiographic imaging apparatus used to produce the radiographic image, and combining the first correction image with the preparatory image to produce and store a second correction image, and
correcting shading of a radiographic image obtained by radiographing the subject by removing one of the first correction image and the second correction image depending upon the target/filter combination used for radiographing the subject from the radiographic image obtained by radiographing the subject.

2. The radiographic image correction method according to claim 1,
wherein the preparatory image and the first correction image are produced for every set of imaging conditions under which the radiographic image obtained by radiographing the subject is produced.

3. The radiographic image correction method according to claim 2,
wherein each of the imaging conditions includes one of the target/filter combinations, a time period during which an electric voltage is applied to the radiation detector, a dose of radiation used, and a focus size.

4. The radiographic image correction method according to claim 1, wherein shading correction on a radiographic image obtained by radiographing the subject using the target/filter combination causing the most significant inconsistent density is performed using the second correction image, and
wherein shading correction on other radiographic images obtained by radiographing the subject is performed using the first correction image.

5. The radiographic image correction method according to claim 1,
wherein a molybdenum target and a tungsten target are used as the targets, and a molybdenum filter and a rhodium filter are used as the filters.

6. The radiographic image correction method according to claim 5,
wherein the target/filter combinations includes a combination of a molybdenum target and a molybdenum filter, a combination of a molybdenum target and a rhodium filter, and a combination of a tungsten target and a rhodium filter.

7. The radiographic image correction method according to claim 5,
wherein shading correction on a radiographic image obtained by radiographing the subject with any one of the target/filter combinations including the rhodium filter is performed using the second correction image, and
wherein shading correction on other radiographic images obtained by radiographing the subject with other target/filter combinations is performed using the first correction image.

8. The radiographic image correction method according to claim 1,
wherein shading correction is performed on a radiographic image obtained by radiographing a breast as the subject.

9. A radiographic imaging apparatus comprising:
a plurality of targets each generating radiation when struck by electrons and a plurality of filters each transmitting the radiation therethrough generated by one of the targets used therewith to adjust a dose of radiation,
target changing means for changing a target and filter changing means for disposing a filter in a given position according to a selected one of target/filter combinations each containing one of the targets and one of the filters,
a radiation detector for producing a radiographic image from radiation transmitted through the filter,
preparatory image storage means for previously producing and storing a preparatory image obtained by removing a radiographic image without the subject obtained using one of the target/filter combinations causing a least significant inconsistent density from a radiographic image without the subject obtained using one of the target/filter combinations causing a most significant inconsistent density,
correction image storage means for producing and storing a first correction image without the subject obtained by radiography using the target/filter combination causing the least significant inconsistent density, producing and storing a second correction image obtained by combining the first correction image with the preparatory image stored in the preparatory image storage means, and renewing the first correction image and the second correction image at a given timing, and
shading correction means for performing shading correction on the radiographic image obtained by radiographing the subject by selecting either the first correction image or the second correction image stored in the correction image storage means depending upon the target/filter combination used for radiography and removing a selected correction image from the radiographic image obtained as the radiation detector radiographs the subject.

10. The radiographic imaging apparatus according to claim 9,
wherein the preparatory image and the first correction image are produced for every set of imaging conditions under which the radiographic image obtained by radiographing the subject is produced.

11. The radiographic imaging apparatus according to claim 10,
wherein each of the imaging conditions for radiographing the subject includes one of the target/filter combinations, a time period during which an electric voltage is applied to the radiation detector, a dose of radiation used, and a focus size.

12. The radiographic imaging apparatus according to claim 9,
wherein the shading correction means uses the second correction image to perform shading correction on a radiographic image obtained by radiographing the subject using the target/filter combination including the filter causing the most significant inconsistent density, and
wherein shading correction on other radiographic images obtained by radiographing the subject is performed using the first correction image.

13. The radiographic imaging apparatus according to claim 9,
wherein a molybdenum target and a tungsten target are used as the targets, and a molybdenum filter and a rhodium filter are used as the filters.

14. The radiographic imaging apparatus according to claim 13,
wherein the target/filter combinations includes a combination of a molybdenum target and a molybdenum filter, a combination of a molybdenum target and a rhodium filter, and a combination of a tungsten target and a rhodium filter.

15. The radiographic imaging apparatus according to claim 13,
wherein the shading correction means uses the second correction image to perform shading correction on a radiographic image obtained by radiographing the subject using a target/filter combination including the rhodium filter, and uses the first correction image to perform shading correction on other radiographic images obtained by radiographing the subject using other target/filter combinations.

16. The radiographic imaging apparatus according to claim 9,
wherein shading correction is performed on a radiographic image obtained by radiographing a breast as the subject.
